(19) United States
(12) Patent Application Publication
(10) Pub. No.: US 2009/0248824 A1
(43) Pub. Date: Oct. 1, 2009

(54) THEME-BASED INSTANT MESSAGING COMMUNICATIONS

(75) Inventors: Steven Francis Best, Westford, MA (US); Yue Ma, Beijing (CN); Su Ying Rui, Beijing (CN); Hong Xu, Beijing (CN); Zhi Yu Yue, Beijing (CN)

Correspondence Address: IBM CORPORATION;LOTUS SOFTWARE, ONE ROGERS STREET, CAMBRIDGE, MA, 02142, US

(73) Assignee: International Business Machines Corporation, Armonk, NY (US)

(21) Appl. No.: 12/414,705

(22) Filed: Mar. 31, 2009

(30) Foreign Application Priority Data
Mar. 31, 2008 (CN) 200810088624.8

(51) Int. Cl. G06F 15/16

(52) U.S. Cl. 709/206

(57) ABSTRACT

Instant messaging communications are controlled using themes. A theme is a definition of properties and features of a specific instance of an instant messaging communications environment. Themes are stored at a server computer and may be requested by users of a client computer. Themes may be made available to users based on enterprise policies established by the owner of the server computer. Once downloaded to the client computer, a theme may be personalized by the user of the client computer provided personalization is consistent with the enterprise policy. Inheritance techniques may be used to provide personalized themes that remain consistent with enterprise policy while extending functions not defined in the enterprise policy. A user may select different themes manually. Alternatively, theme selection may be automated based on system detection of events such as time of day, user location, availability of network connections and the like. Changes in a downloaded theme may be returned to and stored by the server for future use by the user of the client computer.

### BACKGROUND

The present invention relates generally to Instant Messaging (IM) communications and more specifically to theme-based IM communications.

IM computer systems are widely used for personal and business on-line communications. People use IM services for one-on-one casual chats, to discuss problems, to exchange information, and even to conduct meetings. IM has become a basic communication tool.

Current IM software support functions and settings beyond those required for simple on-line chats. For example, an IM user can control the user's on-line status, create user-defined status messages that may be seen by other IM users and set up alert messages to be delivered to the IM user if predetermined changes are detected in the on-line status of certain IM contacts. An IM system may include a black list/blocking function that enables an IM user to block messages from certain other IM users. In some systems, blocked users will be unable even to see the blocking user's IM status. Some IM software enables users can also initiate communication tasks well beyond on-line chatting, such as initiating a telephone call to a contact or generating a regular email message to the contact. IM software typically allows a user to implement at least a limited set of personal preferences for a currently active IM session and may have security-related settings as well. The above and more IM settings together form a communication environment for a user.

As the use of IM systems becomes more pervasive, it is more difficult for users to manage IM system settings for different situations. Specifically, users may employ the same IM system for different purposes in different situations; for example, while working in a regular office, while working at home, while participating in an on-line meeting, while engaging in personal chats, while on vacation, and so on. Such different situations can call for different IM system settings.

For example, assume a user is urgently trying to complete a customer proposal, needs to use an IM service to contact her team members, but finds that her friends keep sending her chat messages about trivial matters. The harried user may resort to blocking her friends to keep them from interrupting her with personal messages. Once the proposal is completed, the user may decide it is again OK for her friends to contact her so she ends the blocking of her friends. However, terminating blocking of her friends will have no effect on the ability of her co-workers to continue asking on-line questions about technical problems, even problems that don't need to be resolved until the next working day.

Another example of different IM requirements for different situations involves an alert function. An IM user may, during normal working hours, want to receive an alert that a certain co-worker is now on-line. However, outside normal working hours, that same IM user may not care whether the co-worker is on-line but may instead want to be alerted when a friend comes on-line. The IM user needs different alert settings at different times, but does not want to have to change the alert settings manually every day.

Problems such as the above recur every day. IM users use IM services in different situations for different purposes. With a change of the user's situation, settings for the IM services also need to be changed. With current IM software, there is no easy way to implement the needed changes.

A failure to properly manage and control an IM system may create security and productivity problems for a business that relies on the IM system. As mentioned above, current IM systems have many capabilities beyond simple on-line chats, such as audio/video conferencing, file transfers, and on-line gaming. Further, IM clients may be implemented on wireless devices such as smart phones, personal digital assistants, netbook computers and notebook computers. The use of the IM system file transfer function from a wireless device may result in exposure of an enterprise's sensitive information. The availability of on-line games can raise a concern that employees might spend time playing games instead of working. The effective management and control of IM communications is a challenge for an IT department in an enterprise. However, it often is not reasonable for an enterprise to completely disable such functions in the IM system as situations may exist where the functions serve an important business purpose.

For example, a software development company may have a general policy that its workers will not play on-line games during working time. However, it may not be realistic to enforce such a policy as to all employees if the company has two departments that are responsible for developing games for IM software. Assume Department A is working on the development of game GA and Department B is working on the development of game GB. An employee assigned to one of those departments may have a legitimate need to be able to play on-line games or at least to be able to play the on-line game the employee's department is developing.

Problems of the type discussed above are common. Enterprises need to control their IM systems to provide different capabilities for different users. Meanwhile, IM users may want to further easily personalize their IM clients within the limits of interprise policies. There is currently no easy way to achieve those objectives.

### SUMMARY

The invention may be implemented as an instant messaging computer system including an instant messaging server computer and an instant messaging client computer. The server computer includes a data storage module for storing a plurality of instant messaging themes with each theme defining elements of an instance of an instant messaging client system, an input module for receiving requests for instant messaging themes, a processing module for processing received requests in order to identify and retrieve a stored theme, and an output module for sending the retrieved theme to a requester. The client computer includes an output module for sending a request for a theme to the server computer, an input module for receiving the theme from the server computer, a data storage module for storing the received theme and a processing module for recalling the received theme and creating an instance of the theme for use by a user of the client computer.

The invention may also be implemented as a method for controlling the use of instant messaging client system instances in a computer system. An instant messaging server computer stores a plurality of instant messaging themes, each theme defining elements of an instant messaging client system instance, receives requests for themes, processes the received requests to identify and retrieve a stored theme and sends the retrieved theme to a requester. An instant messaging client computer sends a request for a theme to the server computer, receives a theme from the server computer, stores the received theme, recalls the stored theme and creates an instance of the theme for use by a user of the client computer.

The invention may also be implemented as an instant messaging server computer for use in an instant messaging computer system and including a data storage module for storing client system themes, each theme defining elements of an instant messaging client system instance, an input module for receiving requests for instant messaging themes, a processing module for processing received requests to identify and retrieve a stored instant messaging theme, and an output module for sending a retrieved instant messaging theme to a requester.

The invention may be implemented as a method performed in an instant messaging server computer for controlling the use of instant messaging client system instances in a computer system. The server computer stores themes with each theme defining elements of an instant messaging system instance, receives requests for the themes, processes the received requests to identify and retrieve a stored theme and sends a retrieved theme to a requester.

The invention may be implemented as a computer program product for controlling the use of instant messaging client system instances in a computer system. The computer program product includes a recording medium having computer usable program code recorded thereon. The program code, when loaded into and executed by a server computer, causes the server computer to store instant messaging themes, each theme defining elements of an instant messaging system instance, receive requests for instant messaging themes, process the requests to identify and retrieve a stored instant messaging theme, and send the retrieved theme to a requester.

The invention may be implemented as an instant messaging client computer for use in a computer system and including an output module for sending a request for an instant messaging client system theme to a server computer, an input module for receiving a theme from the server, a data storage module for storing the received theme, and a processing module for recalling the stored theme and creating an instance of the stored theme for use by a user of the client computer.

The invention may be implemented as a method performed in an instant messaging client computer. The method includes sending a request for an instant messaging client system theme to a server, receiving a theme from the server, storing the received theme in a data storage module, recalling the stored theme and creating an instance of the theme for use by a user of the client computer.

The invention may be implemented as a computer program product for controlling the use of instant messaging client system instances in a computer system. The computer program product includes a recording medium having computer usable program code recorded thereon. The program code, when loaded into and executed by a client computer, causes the client computer to send a request for an instant messaging theme to a server, receive a theme from the server, store the received theme in a data storage module, recall the theme and create an instance of the recalled theme for use by a user of the client computer.

### BRIEF DESCRIPTION OF THE SEVERAL VIEWS OF THE DRAWINGS

FIG. 1 illustrates elements that can be used to define an IM theme in accordance with an embodiment of the present invention.

FIG. 2 shows a user interface (UI) for creating an IM theme in accordance with an embodiment of the present invention.

FIG. 3 shows a user interface for selecting and managing an IM theme in accordance with an embodiment of the present invention

FIG. 4 depicts deployment and management of IM themes using an IM communication policy in accordance with an embodiment of the present invention.

FIG. 5 is a system architecture for implementing IM themes in an IM communication environment in accordance with an embodiment of the present invention.

FIG. 6 is a flowchart illustrating a method for selecting and invoking themes in IM communications in accordance with an embodiment of the present invention.

FIG. 7 is a representation of the hardware elements of a computer that might be used to implement either an instant messaging server computer or an instant messaging client computer in accordance with the invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) to be executed in a suitable computer or an embodiment combining software and hardware aspects that may all generally be referred to herein as a “circuit,” “module” or “system.” Furthermore, the present invention may take the form of a computer program product embodied in any tangible medium of expression having computer-usable program code recorded in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. A non-exhaustive list of possible computer-readable mediums would include: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, for use as a computer component. In the context of this document, a computer-usable or computer-readable medium may be any medium that can contain, store, communicate, or transport the program for use by or in connection with an instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The embodiments of the present invention will be described in detail by reference to the following figures. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

As noted earlier, an IM system user can have different requirements for the settings of the IM system where the system is used in different situations or for different purposes. Each set of settings defines a different IM communication environment for the IM user. The multitude of sets of different IM settings an IM user may typically need are, in accordance with the invention, managed as IM themes. Different themes define different IM communication environments or instances for users. A user-defined theme is considered to be an instance of the original theme. Each theme can include situation-specific IM system settings for system features and functions such as buddy lists, black lists, alerts settings, status settings, status messages, security policies, available actions, and the like. As will be explained in more detail below, users can create new themes based on existing themes and can switch among themes very easily, possibly automatically based on user profiles. Themes can have an inheritance hierarchy for easy creation and management. Moreover, applying themes based on enterprise policies permits the enterprise to flexibly manage and personalize an IM system employed by the enterprise. An enterprise policy can define which IM system capabilities are available to which users. Even where an enterprise policy provides a general definition of the IM system capabilities that are available to a specific IM user, that user may be able to further personalize his/her IM client by creating a personalized theme which inherits from the theme specified by the enterprise policy.

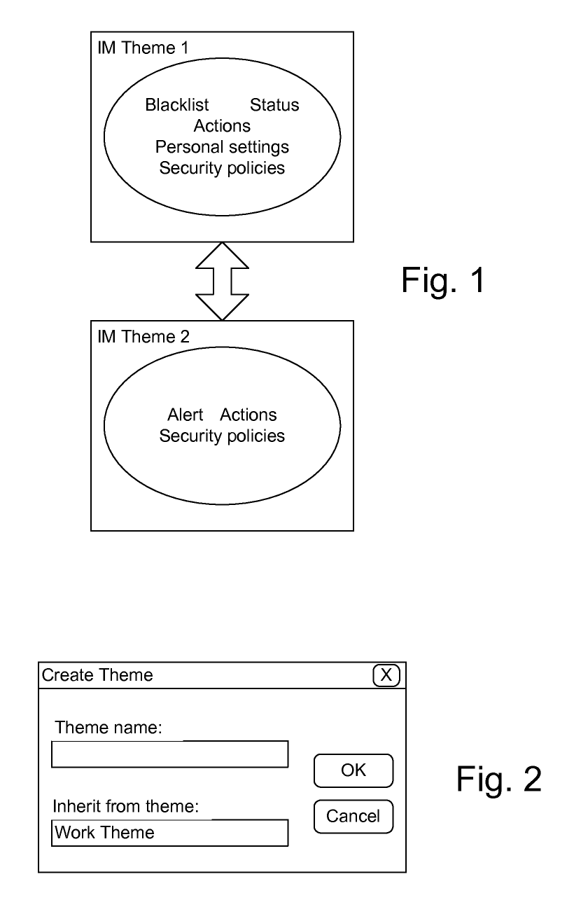

FIG. 1 illustrates several of the parameters or elements that can be used in defining IM themes. Different settings of the same parameters or elements result in different themes or communication environments for users, for example, IM Theme 1 and IM Theme 2. An IM theme can be defined by specific settings for such elements as a contact list (buddy list) structure, black list/blocking settings, alert settings, a default status, a user-defined status, status messages, security policies, available actions, and other IM user personal settings.

Most IM users maintain one or more buddy lists; i.e., lists of people frequently contacted via the IM service. This list can be displayed on the IM clients (e.g., a desktop computer, laptop computer, Personal Digital Assistant (PDA), mobile device and the like). For different IM themes, different buddy lists can be configured, for example, the buddy list in IM Theme 1 may be different from the buddy list in IM Theme 2 even where both themes are to be used by the same IM user. A buddy list can be used to provide additional information about the users in the list. For example, the buddy list can provide textual or iconic representations of a user's IM status (e.g., “on-line” or “off-line”), display user-defined status messages (e.g., “out of the office” or “on vacation in France”), display system-provided messages (e.g., “log in at 10:00 AM”) and so on. Similarly, if an IM user does not want to be disturbed by a particular person, the IM user can select that person's name from the buddy list and, in addition to setting the current status to “do not disturb”, select the black list/blocking function provided by the IM service to block the particular person from sending chat messages or even determining the IM user's on-line status. Moreover, an IM user can set up alert messages to be generated upon predetermined contact status changes (e.g., “Tom is logging in”) or other event information (e.g., “There will be a power outage on Wednesday”).

In some IM software, users can initiate other communications tasks beyond engaging in on-line chats; e.g., initiating a telephone call, sending an email, sharing a document, activating a Webcam link, etc. Therefore, to define different IM themes, an IM user enters the functions and settings for each of those themes; for example, enabling a document sharing function in IM Theme 1 while disabling the same function function in IM Theme 2.

Security-related settings may be different for different themes. For example, in IM Theme 1, a security-related setting may prevent an IM user from performing file transfers with external networks while a security-related setting in IM Theme 2 may allow an IM user perform file transfers with external networks provided the files don't exceed a certain size. By configuring the security-related settings, users can implement security policies applicable to different environments so as to ensure the security and validity of their IM communications.

FIG. 2 shows a user interface for creating an IM theme in accordance with an embodiment of the present invention. There are multiple ways to create a theme, for example, by manual configuration of all the relevant function/feature settings, by exchanging or downloading existing themes or by creating a theme that inherits from a pre-existing theme. Two possible ways to create an IM theme are shown in FIG. 2, i.e. manual creation and inheritance creation. Manual creation requires that an IM user enter desired settings for functions/features such as a buddy list, user blocking, alerts, etc. For example, the user can manually define a “Vacation Theme” such as the following:
Title: Vacation Theme;
Buddy list structure: Shopping Friends, Gaming Friends, Tennis Club, Family, Colleagues, VIPs in company;
Blocking setting: block contacts in Colleague group; and
Actions: Voice talk enabled, document share enabled.

In this theme, the contacts in the colleague group are blocked so they can not contact the user. In addition, the user enables the functions of voice talk and document share by setting available actions, but does not define other functions such as a Webcam function.

Sometimes, data such as a buddy list for setting theme elements can be obtained from external sources. For example, the user can have one “My department” group in a work theme, and obtain all the contacts in this group from the human organization data stored somewhere, such as in a centralized enterprise database.

Themes can also be created in an exchange process. For example, an IM user can acquire an IM theme from another IM user and deploy the IM theme locally. Similarly, an IM user can also download an IM theme from a network and apply it in a local IM client. The theme exchange can occur between IM clients, between an IM client and an IM server, and between IM clients/servers with other communication devices providing IM themes.

Moreover, a theme can be created by inheritance. Just like the classes in an object oriented programming language, a theme can have a structure. A user can create a new theme by derivation from a parent theme. Theme inheritance enables an IM user to extend an existing theme while preventing any change of existing settings in the parent theme. Only undefined IM client capabilities can be extended. For instance, if a file transfer function is disabled in a parent theme, that function cannot be enabled in any child theme. Referring to the above example of “Vacation Theme”, assume a user wants to create a new theme titled as “Thanksgiving Theme”. Given Thanksgiving is considered an extremely important family holiday, the IM user may anticipate increased communications with the user's family and or friends, at least some including Webcam calls. The IM user can create a Thanksgiving theme by inheritance from the “Vacation Theme”, and then by enabling a Webcam function. The “Thanksgiving Theme” can be defined as:
Title: Thanksgiving Theme;
Buddy list structure: Shopping Friends, Gaming Friends, Tennis Club, Family, Colleagues, VIPs in company;
Blocking setting: block contacts in Colleague group; and
Actions: Voice talk enabled, document share enabled, Webcam enabled.

By using theme inheritance as described above, a personalized theme can be created easily and quickly. It should be noted that if settings in a parent theme are changed, then changes will be automatically deployed to all child themes inheriting from this parent theme.

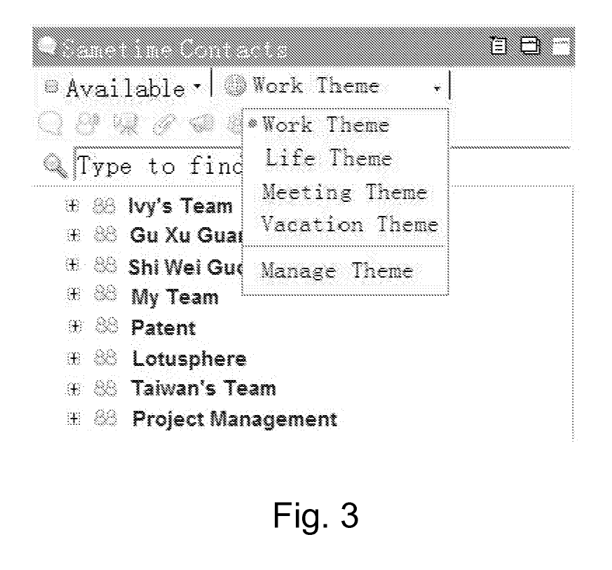

After the creation of an IM theme is completed, the IM theme and its settings can be managed to reflect the situations in which instances of the theme will be used. FIG. 3 shows a user interface for managing an IM theme in accordance with an embodiment of the present invention. Various operations, which can be performed for any IM theme (such as adding, editing and deleting a theme) may be included within a toolbar in the user interface. The currently selected IM theme is a “Work Theme”. In one embodiment, management functions for the currently selected theme may be accessed by selecting a “Manage Theme” menu entry. Typical management functions include adding and deleting names on a buddy list, modifying alert settings, enabling available functions, and etc. Such management can be performed not only for the entire theme but also for one or more elements in a certain theme. In another embodiment, a user can add a new theme or delete an existing theme by selecting “Manage Theme”.

The use of IM themes provides a way for managing IM capabilities dynamically and easily. Users can switch IM themes very easily with few mouse clicks or keystrokes. Once a different theme is selected, its settings are also automatically implemented in an instance of the selected theme. FIG. 3 shows four alternative themes. An IM user can quickly select any of the listed themes in a simple manual selection operation. It should be noted that the menus, options, buttons or icons shown in FIG. 3 are merely an example of one embodiment, and further embodiments of the present invention can utilize other features or elements to perform functions provided by IM communications systems.

The preceding discussion has been limited to manual selection of alternative IM themes by an IM user. It is within the scope of the invention to enable automated selection of IM themes through the use of user profiles. Possible criteria for automatic selection of IM themes include time of day, IM user location, client network/IP address, the occurrence of calendar events, and other criteria, including criteria which are not directly associated with the IM system.

As an example, a IM client theme, “Working Theme” may be automatically selected based on a time frame specified in a user profile, like “starts at 8:00 AM, ends at 5:30 PM”. By using the Date/Time function standard in computers, the Working Theme may be activated/deactivated automatically each working day. As another example, automatic theme switches may be based on detected location changes. Assume an IM client theme “Meeting Room L Theme”, is defined per a user profile. When the user initiates an request for IM services, an IM server may, by identifying an IP address, detect that the user is located in Meeting Room L and then switch automatically to the Meeting Room L Theme. Automatic theme selection may also based on available network connections. For example, when the user requests an IM service at his/her place of business via a LAN (Local Area Network) connection, a “Working Theme” may be automatically selected. However, if the user requests the IM service via a public wireless network connection, the IM Theme may be automatically switched to a “Mobile Theme”. Similarly, if the user requests the IM service at his/her home via a home network connection, the IM theme may be automatically switched to a “Life Theme”.

In some systems, an IM client is integrated with e-Mail, e-Calendar and other systems that may provide the information needed to automate theme switching. Meeting information in a personal calendar is a good resource for automated theme switching. When a meeting time arrives, the IM service can automatically switch to a “Meeting Theme”. The above are offered only as examples. Other factors may be used in automating theme switching.

A network device such as an IM server may serve as a repository of IM themes that can be made available to supported IM client devices. After a client user uses or modifies server-provided IM themes in different situations or modifies a server-provided theme, the IM settings of the theme are preferably saved and sent to the IM server so that the IM settings are consistent (i.e. IM theme data is synchronized) when the user reuses this theme at other time or location.

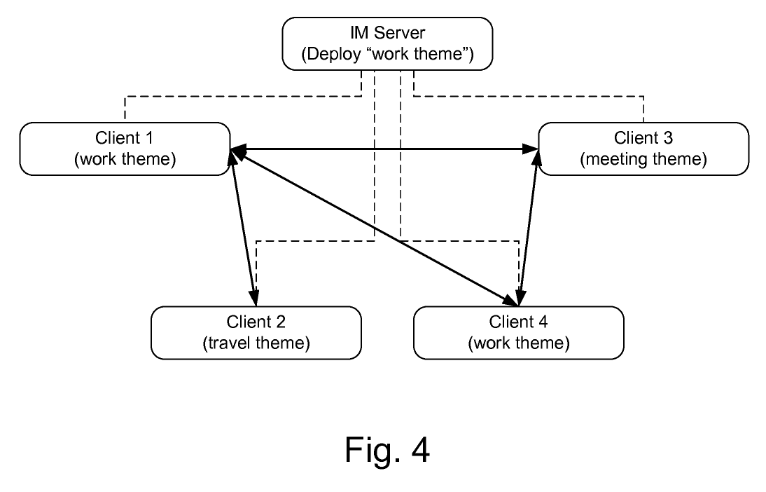

FIG. 4 depicts management of IM themes in accordance with an IM communication policy. Different themes can be selected to be applied in different IM communication situations, and an IM communication context can be configured according to the specified IM settings in a selected theme. Moreover, an enterprise environment may have policy requirements on IM communications. Making IM themes available based on IM communication policies provides a flexible method for management and personalization of IM themes in an enterprise.

According to one embodiment of the invention, the selection and deployment of IM themes can be managed by a policy that establishes theme inheritance. For example, assume enterprise ABC deploys an IM system as its internal communication tool and enables theme management by a policy that requires new themes be created by inheritance from a “Root Theme” available from the enterprise's central IT team. The Root Theme may be equated to a basic Work Theme that defines a buddy list structure based on the enterprise employee structure and that precludes file transfers with people outside the enterprise.

In a large enterprise, specific departments can have varying themes that inherit from a company-wide theme. Accordingly, each employee is able to extend the “Work Theme” to his/her own theme with theme inheritance. For example, an employee may define a “Meeting Theme” which inherits from the “Work Theme” (as Client 3 shown in FIG. 4), in which it has the same buddy list organization as that of the work theme and returns an auto-reply “In a meeting, will reply later” to anyone who pings this employee while the “Meeting Theme” is active. Another example is a salesman who travels frequently may define a “Travel Theme” which inherits from the “Work Theme”, as Client 2 shown in FIG. 4. In other scenarios, employees can personalize their own themes used in working time by inheriting the “Root Theme”.

An enterprise policy for managing the deployment and selection of IM themes will identify the properties of the themes, specifying when they are to be used and by whom they are to be used. An enterprise policy may also require that all employees in the enterprise intranet use the work theme or another theme inheriting from the work theme during their normal working time. An example of an IM communication policy is:

Condition—It could be time-based or IP address based. For example, during working time, or when in office IP range;

Which—Work Theme (including its child themes); and

Whom—Which employee. It can be defined by conditions that are applied to a user ID (e.g. an email address), or other ways to select a user ID and an IM client.

By providing a “Root Theme” together with a corresponding IM communication policy, an enterprise may have a basic control of the IM communication capability of each employee. Departments can have their themes inherited and add more specific controls so as to enable employees within the departments to apply themes under the specific controls in IM communications. Each employee may still be able to personalize an inherited IM theme without being able to implement theme changes inconsistent with enterprise policy.

Enterprise policies may also be used to control the deployment of specific themes in response to external events; such as when a certain kind of IM virus/worm is spreading across the Internet. If the virus/worm is disseminated by IM file transfer, the enterprise may deploy an “Anti-XXX Virus Theme”, which disables file transfers with a certain name. It should be noted that all of child themes inheriting from a theme will be added as the themes permitted to be applied under certain conditions, if the theme is specified as the theme permitted to be applied under such conditions by using a policy.

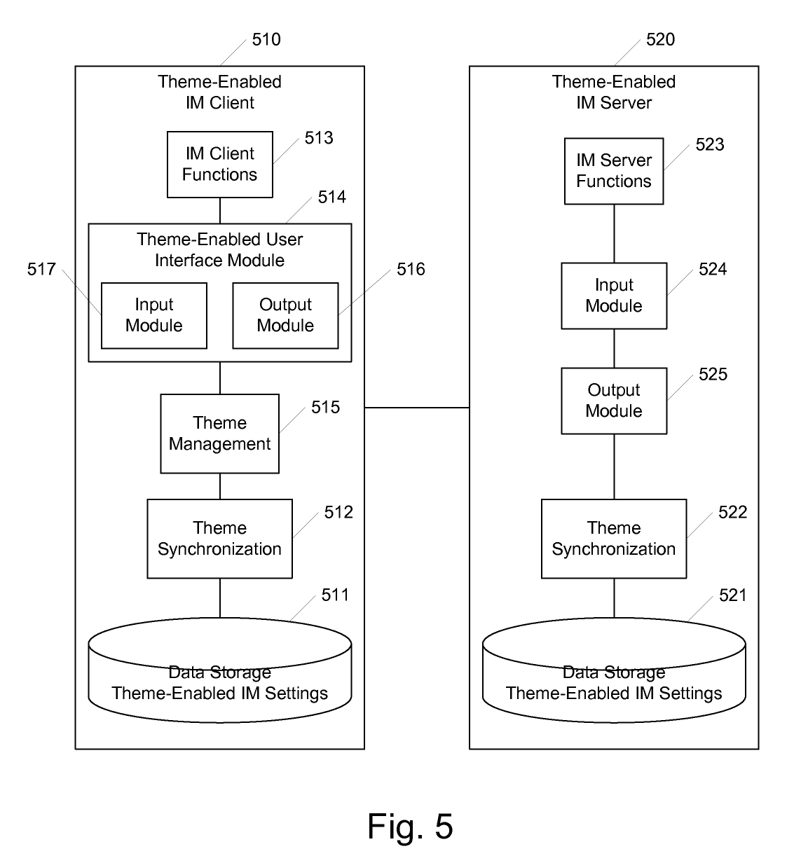

FIG. 5 is a system architecture 500 for implementing IM themes in an IM communication environment in accordance with an embodiment of the invention. A system architecture 500 includes a theme-enabled IM client 510 and a theme-enabled IM server 520. The theme-enabled IM client 510, the theme-enabled IM server 520, and any or all of their components may execute on a computer system such as one or more of a personal computer, workstation, server, mainframe computer, notebook or laptop computer, tablet PC, desktop computer, portable computer system, PDA, set-top box, mobile phone, wireless device, or the like. The theme-enabled IM client 510 and the theme-enabled IM server 520 can support information exchange and data transmission via communication channels such as networks (not shown) such as the Internet, an intranet, a LAN, a Wide Area Network (WAN), a Virtual Private Network (VPN), an Ethernet network, a wireless network, etc. Furthermore, the system architecture 500 may include additional servers, clients and other devices not shown.

In one embodiment of the present invention, in addition to a conventional IM client functional module 513, the theme-enabled IM client 510 also comprises theme-based IM communication modules for implementing the invention, including a theme-enabled IM settings module 511 for providing data storage of theme settings, a theme synchronization module 512, a theme user interface module 514 including an output module 516 for sending requests to server 520 and an input module 517 for receiving responses from the server 520, and a theme management module 515, all as depicted in FIG. 5. Similarly, in the theme-enabled IM server 520, in addition to a conventional IM server functional module 523, FIG. 5 also depicts theme-based IM communication modules for implementing the invention, which include an input module 524 for receiving requests from the client 510 and an output module 524 for sending responses to the client 510, a theme-enabled IM settings module 521 for providing data storage of theme settings and a theme synchronization module 522.

Through the theme user interface module 514, a user can request IM communication services for creating, applying, adjusting, switching and managing themes. Alternatively, functions provided by the theme user interface module 514 can be performed on an existing user interface of an IM system. The user interface may be any specific type of user interface, such as, for example, a graphical user interface, and may be navigated by each respective user through any specific type of user interface device, such as a computer keyboard or mouse, and/or using voice commands or the like, so that a variety of operations and functions related to IM themes are implemented, as shown in FIG. 3.

An IM theme applied locally and its settings or setting structure are stored in the theme-enabled IM settings data storage module 511 of the IM client 510, and all themes and their associated data, which are supported in IM communication contexts provided to one or more IM clients such as the IM client 510 by the IM server 520, are contained in the theme-enabled IM settings data storage module 521 at the IM server 520. In the invention, the theme-enabled IM settings modules 511 and 521, which are located at the IM client 510 and the IM server 520 respectively, may be any type of system capable of providing information storage, e.g. database.

The theme synchronization module 512 at the IM client 510 interacts with an IM server (such as the IM server 520) offering IM services to the IM client 510 and is used to synchronize theme data with this server. The theme synchronization module 512 can retrieve a theme from the IM server and apply this theme in the local IM client. The theme synchronization module 512 may also support theme exchanges among IM clients such as Clients 1, 2, 3 and 4 in FIG. 4, getting theme information from other IM clients (or other IM communication devices) and bridging the corresponding theme to the theme management module 515 for local use. Moreover, the theme synchronization module 512 preferably also delivers locally-generated theme updates to a corresponding IM, in order to maintain the reliability and continuity of a user's IM communication.

The IM server will include a theme synchronization module which performs comparable functions but at the server. The theme synchronization module 522 at the IM server 520 shown in FIG. 5 is used to synchronize theme data with IM clients supported by the IM server 520, so that the server can return current theme settings to provide a consistent IM context when a user requests IM services in different situations.

Theme management module 515 is used to manage a local theme, including dealing with user-initiated requests entered through the theme user interface module 514. The theme management module 515 also provides functions for creating, adding, editing and deleting a theme and its settings. In one embodiment, when a user requests an IM service through the theme user interface module 514, the theme management module 515 responds to the user request, for example, reads and/or writes information about an IM theme from and/or to the theme-enabled IM settings module 511. Alternatively, theme information can be obtained from one or more user information databases external to the client 510 (e.g., from an employee database, or from a user database associated with the theme management module 515 and/or maintained by the theme management module 515). In another embodiment, according to a policy-based theme indicated by the IM server such as the IM server 520, the theme management module 515 adjusts IM communication services on the IM client 510 to apply a corresponding IM theme locally. In the present invention, the theme management module 515 is also used to manage the theme inheritance and deploy theme exchanges with other IM clients. Moreover, it also provides a function of automatically switching themes per a user profile, including time, location, network, event, type of client, and other context factors outside IM.

Although only one client 510 and one server 520 are illustrated for the theme-enabled IM system architecture 500, systems with multiple clients and/or multiple servers can also be used. Moreover, in another embodiment, peer communication capability is controlled individually in a client side, i.e. IM operations such as theme exchanges can be performed between IM clients directly, while there is no change in all communication processes between IM clients.

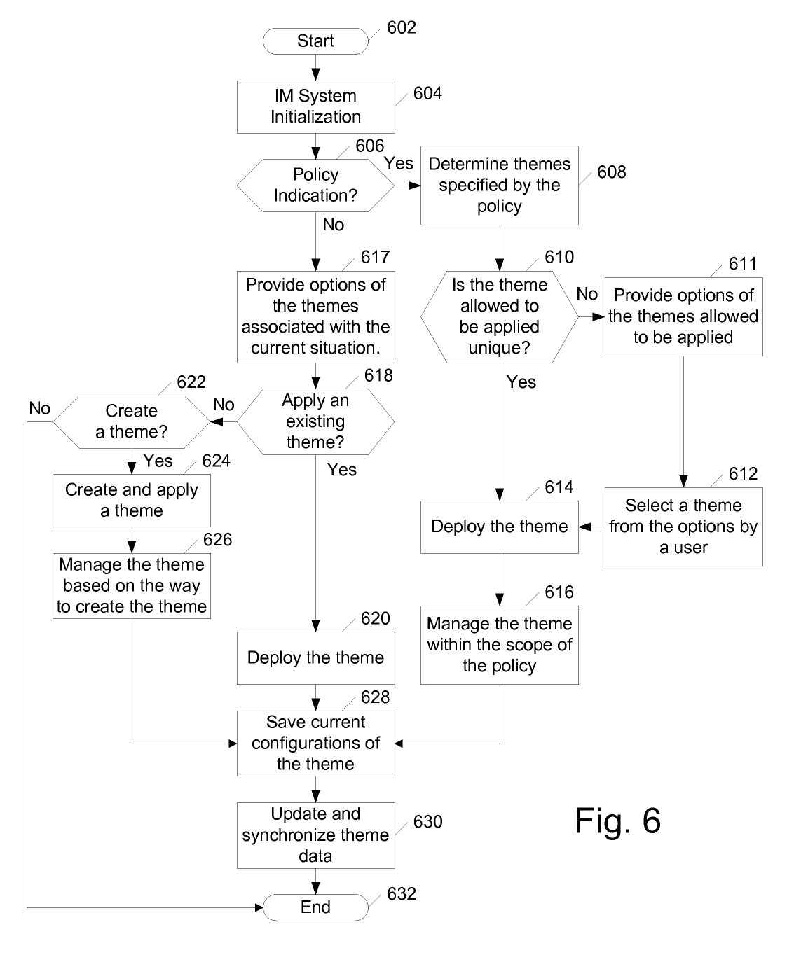

FIG. 6 is a flowchart of a method for managing the deployment and use of IM themes in IM communications in accordance with an embodiment of the present invention. The process commences with step 602, and continues to step 604 to initialize an IM communication context. After a user logs into an IM system, a determination is made as to whether there is an applicable IM policy in step 606. If so, IM themes specified by the policy are identified in step 608. Since the policy qualifies themes which are allowed to be applied, it is necessary to filter out the themes which do not meet the conditions defined by the policy. The qualified themes include themes allowed by the policy as well as their child themes.

If it is determined in step 610 that the theme allowed to be applied is unique for the user, this theme is deployed for the user in step 614. Otherwise, themes the user has the option of selecting are provided to the user in step 611. In response to the selection of one of the available themes, the IM system deploys this theme for the user in step 614. Then, the user can exercise available options to modify or extend this theme in step 616. It can be assumed that because the theme is made available subject to a policy, that the user's ability to modify it is likely to be limited by the same policy. If the user does modify the theme, it is necessary to synchronize the client and the server of the IM system to maintain the consistency of the IM communication context. Thus, current configurations of the theme are saved in step 628, and theme data is updated by a synchronization process between the client and the server, as shown in step 630. Then the process ends.

Returning to step 606, if no enterprise policy is found, then in step 617, the server will identify all themes that appear suitable for the client's situation; i.e., time of day, IP address, etc. If only one theme is considered suitable, that theme is deployed without further user input. If more than one theme is available, the user can select a theme to be used.

In step 618, if it is determined that the user wants to apply an existing theme, the theme selected by the user is deployed, as shown in step 620. In step 626, the user can manage this theme in accordance with the way in which this theme was created. For example, if the user chooses to apply an existing theme created by inheritance, then the user can only modify the capabilities/functions of this theme that are undefined for the parent theme.

Returning to step 618, if it is determined that none of the existing themes meet the user's requirements, it is determined in step 622 whether the user wants to create a theme. If the user does not want to create a theme, the process ends at step 632. Otherwise, the user chooses a mechanism for create the theme, e.g. by configuring it manually, acquiring it by download or exchange or creating it as an inheritance from an existing theme. The created theme is applied locally. The user can modify and maintain the created theme, step 626, based on the way in which the theme was created. In step 628, the system saves current configurations of the theme, and updates and synchronizes theme data, as shown in step 630. The process ends at step 632.

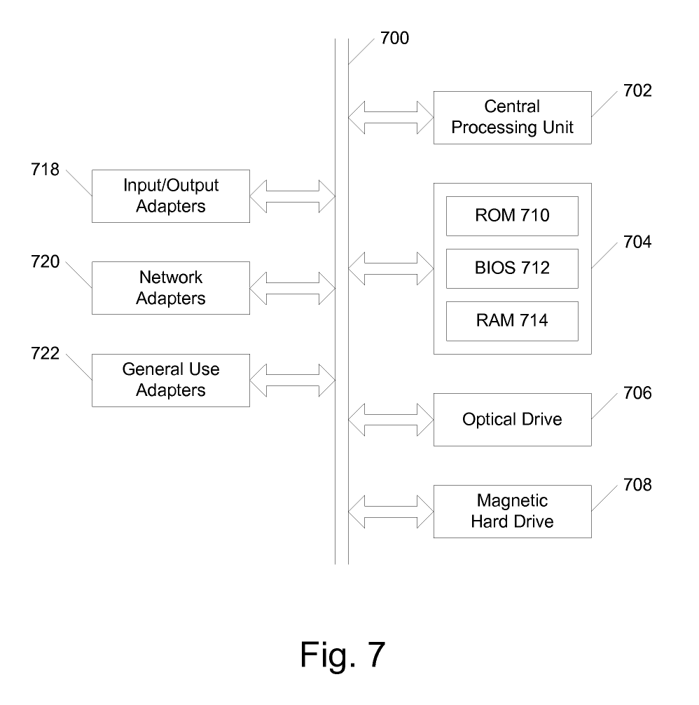

FIG. 7 is the physical infrastructure of a computer system that can implement the methods described above in either an IM client or IM server environment. The computer system includes an internal system bus 700, a system processor 702, internal memory components 704 and one or more “external” memory components, such as an optical drive 706 and a magnetic hard drive 708. The internal memory 704 includes specific types of memory such as read only memory (ROM) 710, basic input/out system (BIOS) memory 712 and random access memory (RAM) 714. The BIOS 712 stores configuration information for the computer system and basic routines used to control the transfer of information among the components of the computer system.

Drives, such as optical drive 706 and hard drive 708, provide non-volatile storage for applications and processes that execute in the computer system and for data used in and/or generated by those applications and processes. Specifically, optical drive 706 and/or hard drive 708 may be used to store IM theme IDs and data required for the Theme User Interface, Theme Management, Theme Synchronization and IM Client/Server modules previously described with reference to FIG. 5. The same drives may store the Theme Enabled IM Settings maintained in both the IM Server and IM Clients.

The computer system also includes a significant number of input/output (I/O) adapters 718 that provide interfaces between a variety of input/output devices and the remainder of the computer system. Common examples of input/output devices include keyboards, pointing devices, monitors and printers.

The computer system can be connected to other systems through network adapters 720, which may support wired or wireless network connections. Finally, the computer system may include what are characterized as general use adapters 722 that can be used for a number of different purposes. For example, USB (Universal Serial Bus) adapters can be used to connect typical input/output devices (such as keyboards, monitors, etc.), auxiliary memory devices, such as flash memory cards, portable hard drives and even high capacity magnetic hard drives, wireless network transceivers and many other kinds of devices to the computer system

Although specific embodiments of the invention have been disclosed, those having ordinary skill in the art will understand that changes can be made to the specific embodiments without departing from the spirit and scope of the invention. The scope of the invention is not to be restricted therefore to the specific embodiments, and it is intended that the appended claims cover any and all such applications, modifications, and embodiments within the scope of the present invention.

What is claimed is:

1. An instant messaging computer system comprising:
an instant messaging server computer comprising
a data storage module for storing a plurality of instant messaging client system themes, each said theme defining elements of an instant messaging client system instance,
an input module for receiving requests for instant messaging client system themes,
a processing module for processing said requests to identify and retrieve a stored instant messaging client system theme, and
an output module for sending a retrieved instant messaging client system theme to a requester; and
an instant messaging client computer comprising
an output module for sending a request for a instant messaging client system theme to said instant messaging server computer,
an input module for receiving a instant messaging client system theme from said instant messaging server computer,
a data storage module for storing said received instant messaging client system theme, and
a processing module for recalling said stored instant messaging client system theme and creating an instance of said theme for use by a user of said instant messaging client computer.

2. An instant messaging computer network as set forth in claim 1 wherein said data storage module in said instant messaging server computer further stores at least one instant messaging communications policy and said processing module processes said requests to identify and retrieve a instant messaging client system theme in accordance with one said instant messaging communications policy.

3. An instant messaging computer network as set forth in claim 2 wherein each said instant messaging communications policy comprises a definition of conditions under which an instant messaging client system theme may be used and a definition of users qualified to make use of instances of said theme.

4. An instant messaging computer network as set forth in claim 3 wherein said processing module in said instant messaging client computer further creates an instance of a stored instant messaging client system theme by inheritance from said stored instant messaging theme.

5. A method of controlling the use of instant messaging client system instances in a computer network comprising:
at an instant messaging server computer
storing a plurality of instant messaging client system themes, each said instant messaging client system theme defining elements of an instant messaging client system instance,
receiving requests for instant messaging client system themes,
processing said requests to identify and retrieve a stored instant messaging client system theme, and
sending a retrieved instant messaging client system theme to a requester; and
at an instant messaging client computer
sending a request for an instant messaging client system theme to said instant messaging server computer,
receiving an instant messaging client system theme from said instant messaging server computer,
storing said received instant messaging client system theme, and
recalling said stored instant messaging client system theme and creating an instance of said instant messaging client system theme for use by a user of said instant messaging client computer.

6. A method as set forth in claim 5 further comprising, at said instant messaging server computer, storing at least one instant messaging communications policy and processing a received request to identify and retrieve a stored instant messaging client system theme in accordance with said stored instant messaging communications policy.

7. A method as set forth in claim 6 wherein each said instant messaging communications policy comprises a definition of conditions under which an instant messaging client system theme may be used and a definition of users qualified to make use of instances of said theme.

8. A method as set forth in claim 7 wherein creating an instance of said stored instant messaging client system theme in said instant messaging client computer further comprises creating an instance of said stored instant messaging client system theme by inheritance from said stored instant messaging theme.

9. An instant messaging server computer for use in an instant messaging computer system, said instant messaging server computer comprising:
a data storage module for storing a plurality of instant messaging client system themes, each said instant messaging client system theme defining elements of an instant messaging client system instance;
an input module for receiving requests for instant messaging client system themes;
a processing module for processing said requests to identify and retrieve a stored instant messaging client system theme; and
an output module for sending a retrieved instant messaging client system theme to a requester.

10. An instant messaging server computer as set forth in claim 9 wherein said data storage module further stores at least one instant messaging communications policy and said processing module processes said requests to identify and retrieve a stored instant messaging client system theme in accordance with a stored instant messaging communications policy.

11. An instant messaging server computer as set forth in claim 10 wherein each said instant messaging communications policy comprises a definition of conditions under which an instant messaging client system theme may be used and a definition of users qualified to make use of instances of said theme.

12. A method performed in an instant messaging server computer for controlling the use of instant messaging client system instances in a computer system comprising:
storing a plurality of instant messaging client system themes, each said instant messaging client system theme defining elements of an instant messaging client system instance,
receiving requests for instant messaging client system themes,
processing said requests to identify and retrieve a stored instant messaging client system theme, and
sending a retrieved instant messaging client system theme to a requester.

13. A method as set forth in claim 12 further comprising storing at least one instant messaging communications policy and processing a received request to identify and retrieve a stored instant messaging client system theme in accordance with said stored instant messaging communications policy.

14. A method as set forth in claim 13 wherein each said instant messaging communications policy comprises a definition of conditions under which an instant messaging client system theme may be used and a definition of users qualified to make use of instances of said instant messaging client system theme.

15. A method as set forth in claim 14 further comprising receiving a record of any changes made in a stored instant messaging client system theme by a user of an instant messaging client computer and storing said changes for possible future use by the user of said instant messaging client computer.

16. A computer program product for controlling the use of instant messaging client system instances in a computer system, said computer program product comprising a recording medium having computer usable program code recorded thereon, said computer usable program code when loaded into and executed by an instant messaging server computer causing said instant messaging server computer to perform a method comprising:
storing a plurality of instant messaging client system themes, each said instant messaging client system theme defining elements of an instant messaging client system system instance;
receiving requests for instant messaging client system themes;
processing said requests to identify and retrieve a stored instant messaging client system theme; and
sending a retrieved instant messaging client system theme to a requester.

17. A computer program product as set forth in claim 16 wherein the method further comprises storing at least one instant messaging communications policy and processing a received request to identify and retrieve a stored instant messaging client system theme in accordance with said stored instant messaging communications policy.

18. A computer program product as set forth in claim 17 wherein each said instant messaging communications policy comprises a definition of conditions under which an instant messaging client system theme may be used and a definition of users qualified to make use of instances of said theme.

19. An instant messaging client computer for use in an instant messaging computer system, said instant messaging client computer comprising:
an output module for sending a request for an instant messaging client system theme to an instant messaging server computer,
an input module for receiving an instant messaging client system theme from said instant messaging server computer,
a data storage module for storing said received instant messaging client system theme, and
a processing module for recalling said stored instant messaging client system theme and creating an instance of said stored instant messaging client system theme for use by a user of said instant messaging client computer.

20. An instant messaging client computer as set forth in claim 19 wherein processing module further creates an instance of a stored instant messaging client system theme by inheritance from said stored received instant messaging client system theme.

21. An instant messaging client computer as set forth in claim 20 wherein said processing module further:
creates a record of changes made in the stored instant messaging client system theme by the user; and
sends the created record to an instant messaging server computer.

22. An instant messaging client computer as set forth in claim 21 wherein said processing module, in response to detection of a predetermined event, automatically creates an instance of a different instant messaging client system theme for use by a user of said instant messaging client computer.

23. A method performed in an instant messaging client computer for controlling the use of instant messaging client system instances in a computer network comprising:
sending a request for an instant messaging client system theme to an instant messaging server computer,
receiving an instant messaging client system theme from said instant messaging server computer,
storing said received instant messaging client system theme in a data storage module, and
recalling said stored instant messaging client system theme and creating an instance of said stored instant messaging client system theme for use by a user of said instant messaging client computer.

24. A method as set forth in claim 23 further comprising creating an instance of an instant messaging client system theme by inheritance from said stored instant messaging client system theme.

25. A method as set forth in claim 24 further comprising
creating a record of changes made in the stored instant messaging client system theme by the user; and
sending the created record to an instant messaging server computer.

26. A method as set forth in claim 25 further comprising
detecting a predetermined event; and
in response to said detection, automatically creating an instance of a different instant messaging client system theme for use by a user of said instant messaging client computer.

27. A computer program product for controlling the use of instant messaging client system instances in a computer network, said computer program product comprising a recording medium having computer usable program code recorded thereon, said computer usable program code when loaded into and executed by an instant messaging client computer causing said instant messaging client computer to perform a method comprising:
sending a request for an instant messaging client system theme to an instant messaging server computer;
receiving an instant messaging client system theme from said instant messaging server computer;
storing said received instant messaging client system theme in a data storage module; and
recalling said stored instant messaging client system theme and creating an instance of said stored instant messaging client system theme for use by a user of said instant messaging client computer.

28. A computer program product as set forth in claim 27 wherein the method further comprises creating an instance of an instant messaging client system theme by inheritance from said stored instant messaging theme.

29. A computer program product as set forth in claim 28 wherein the method further comprises:
creating a record of changes made in the stored instant messaging client system theme by the user; and
sending the created record to an instant messaging server computer.

30. A computer program product as set forth in claim 29 wherein the method further comprises:
detecting a predetermined event; and
in response to said detection, automatically creating an instance of a different instant messaging client system theme for use by a user of said instant messaging client computer.
